(19) United States
(12) Patent Application Publication
(10) Pub. No.: US 2019/0359467 A1
(43) Pub. Date: Nov. 28, 2019

(54) POST-MIX BEVERAGE DISPENSER

(71) Applicant: Sunny Sky Products, LLC, Houston, TX (US)

(72) Inventor: Jon Martin Ferro, San Diego, CA (US)

(21) Appl. No.: 16/418,015

(22) Filed: May 21, 2019

Related U.S. Application Data
(60) Provisional application No. 62/674,811, filed on May 22, 2018.

(51) Int. Cl. B67D 1/00

(52) U.S. Cl. CPC B67D 1/0045; B67D 1/0021

(57) ABSTRACT

A post-mix beverage dispenser includes a dispenser head, a diffuser, and a spout. The bottom of the dispenser head includes an outer wall and an inner wall that defines a channel therebetween which allows for the spout to be coupled thereto. The dispenser head includes a dispenser base formed with the inner wall and defines a diluent port and a concentrate port where the concentrate port is centrally positioned. The diffuser includes a cylindrical wall having a base extend inwardly from wall and which defines a channel within the middle of the base. The channel is aligned with the concentrate port and a portion of the base is aligned with the diluent port. The diffuser is designed to dispense agitated, whipped, foamed or frothed beverages by allowing the diluent to exit the diluent port and hit the base, thereby scattering the diluent into the concentrate stream at a high velocity.

### CROSS REFERENCE TO RELATED APPLICATIONS

This patent application claims priority under 35 U.S.C. § 119(e) to U.S. Provisional Patent Application No. 62/674,811 titled “A Post-Mix Beverage Dispenser” filed on May 22, 2018, the entire content of which is hereby incorporated by reference herein.

### TECHNICAL FIELD

This invention relates generally to beverage dispensers used for dispensing agitated, whipped, foamed or frothed beverages. More particularly, this invention relates to a post-mix beverage dispenser and a diffuser used within such post-mix beverage dispenser.

### BACKGROUND

Restaurants, fast food restaurants, amusement parks, snack places, and other establishments, such as coffee houses, make and serve beverages that are agitated, whipped, foamed or frothed. These beverages are typically made by mixing one or more streams of liquids to form such beverages. In some examples, there are two liquid streams that are mixed together. One stream is a concentrate stream, while another stream is a diluent stream, which is typically, but not always, water. The concentrate does not generally require refrigeration. However, once the concentrate is mixed with the diluent or is exposed to air, the mixture usually requires refrigeration to prevent or minimize bacterial growth.

Typically, there have been two types of dispensers that have been used to make such agitated, whipped, foamed or frothed beverages. These dispensers are a pre-mix dispenser and a post-mix dispenser.

A pre-mix dispenser mixes the concentrate, typically in a syrup liquid form, with the diluent and stores the mixture within a holding tank prior to dispensing the mixture through a nozzle on the dispenser. This pre-mix dispenser suffers disadvantages because the mixture within the holding tank will have bacteria grow within it. These types of dispensers require more maintenance and cleaning than a post-mix dispenser and therefore is not a great option for these establishment types.

Conversely, a post-mix dispenser does not store a mixture of concentrate and diluent. Instead, each of the concentrate and diluent is maintained separately and allowed to mix with one another upon demand for such beverage. The concentrate and the diluent are conveyed through separate conduits through a dispenser head and then allowed to mix with one another while being dispensed through a spout. Generally, there is some mixing of the concentrate and the diluent within a mixing chamber, located within the post-mix dispenser, prior to being dispensed into a cup from the spout; but, the majority of mixing occurs within the cup after the concentrate and diluent has exited the post-mix dispenser through the spout. The concentrate is typically stored apart from the dispenser in a plastic bag, cardboard box or metal container. The concentrate is delivered to the dispenser through a conduit. The diluent, however, is typically sourced through a conduit tapped into a municipal water line, which may be filtered along the way to the post-mix dispenser.

There is a need for an apparatus that can provide mixing of the concentrate and diluent streams prior to exiting the dispenser into the cup while increasing the frothiness and foaminess of the dispensed beverage. There is a need for an apparatus that can provide mixing of the concentrate and diluent streams prior to exiting the dispenser into the cup that is durable and easy to maintain design.

### BRIEF DESCRIPTION OF THE DRAWINGS

The foregoing and other features and aspects of the invention will be best understood with reference to the following description of certain exemplary embodiments of the invention, when read in conjunction with the accompanying drawings, wherein:

FIG. 1 shows a partially fragmented perspective view of a post-mix beverage dispenser in accordance with an exemplary embodiment of the present invention;

FIG. 2 shows a partially fragmented perspective view of a post-mix beverage dispenser in accordance with another exemplary embodiment of the present invention;

FIG. 3 shows a partially exploded side perspective view of a post-mix beverage dispenser illustrating a diffuser in accordance with an exemplary embodiment of the present invention;

FIG. 4 shows a partial bottom view of the post-mix beverage dispenser with the spout removed in accordance with an exemplary embodiment of the present invention;

FIG. 5 shows a partial bottom view of the post-mix beverage dispenser with the spout and the diffuser removed in accordance with an exemplary embodiment of the present invention;

FIG. 6A shows a top perspective view of the diluent nozzle 530 in accordance with an exemplary embodiment of the present invention;

FIG. 6B shows a top view of the diluent nozzle 530 in accordance with an exemplary embodiment of the present invention;

FIG. 6C shows a side view of the diluent nozzle 530 in accordance with an exemplary embodiment of the present invention;

FIG. 7A shows a top perspective view of the diffuser 380 in accordance with an exemplary embodiment of the present invention;

FIG. 7B shows a bottom perspective view of the diffuser 380 in accordance with an exemplary embodiment of the present invention;

FIG. 7C shows a top view of the diffuser 380 in accordance with an exemplary embodiment of the present invention;

FIG. 7D shows a side view of the diffuser 380 in accordance with an exemplary embodiment of the present invention;

FIG. 7E shows a cross-sectional view of the diffuser 380 along A-A in FIG. 7D in accordance with an exemplary embodiment of the present invention; and

FIG. 7F shows a bottom view of the diffuser 380 in accordance with an exemplary embodiment of the present invention.

The drawings illustrate only exemplary embodiments of the invention and are therefore not to be considered limiting of its scope, as the invention may admit to other equally effective embodiments.

### DETAILED DESCRIPTION OF THE INVENTION

This invention relates generally to beverage dispensers used for dispensing agitated, whipped, foamed or frothed beverages. More particularly, this invention relates to a post-mix beverage dispenser and a diffuser used within such post-mix beverage dispenser. Although the description provided below is related to a particular diffuser positioned within a post-mix beverage dispenser, exemplary embodiments of the invention relate to any diffuser that benefits from having certain features as discussed below. The post-mix beverage dispenser and the diffuser used within such post-mix beverage dispenser of the embodiments of the invention described herein below are designed to remove and/or reduce any collection points for product-related bacteria and are designed with improved structural integrity compared with other post-mix beverage dispensers and diffusers of the prior art.

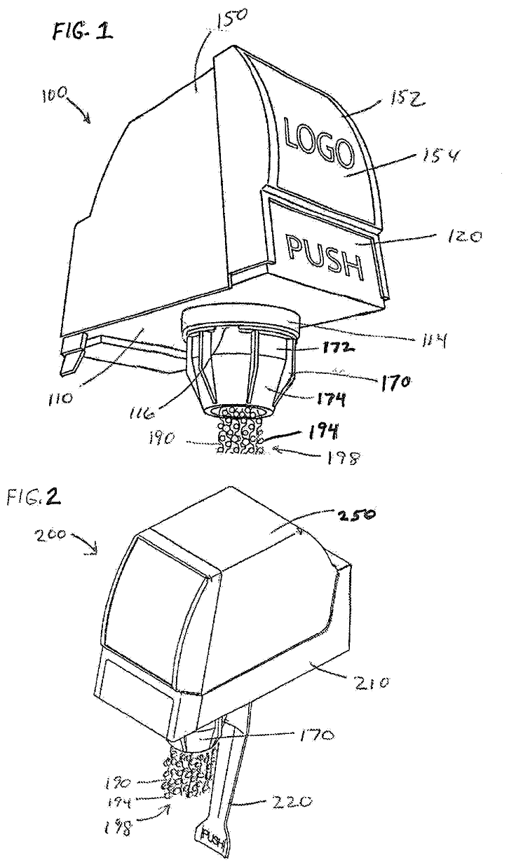

FIG. 1 shows a partially fragmented perspective view of a post-mix beverage dispenser 100 in accordance with an exemplary embodiment of the present invention. The post-mix beverage dispenser 100 includes a dispenser head 110, a cover 150, and a spout 170. The dispenser head 110 includes a generally cylindrical outer wall 114 formed at the bottom of the dispenser head 110 and extending outwardly therefrom and a generally cylindrical inner wall (not shown) formed interior of the outer wall 114 and extending outwardly from the bottom of the dispenser head 110, thereby forming a channel (not shown) between the outer wall 114 and the inner wall (not shown). The outer wall 114 also includes one or more key slots 116 for receiving and locking in the spout 170 once coupled to the dispenser head 110 via the channel (not shown). The dispenser head 110 includes necessary components and conduits (not shown) for dispensing a diluent 190, typically water, and a syrup or concentrate 194. The dispenser head 110 may also include a button 120, located at the front of the dispenser head 110, which may be depressed to allow dispensing of the diluent 190 and the syrup or concentrate 194. The dispenser head 110, upon depressing the button 120, dispenses the diluent 190 and the syrup or concentrate 194 separately from one another in an unmixed state into the spout 170. Within the spout 170, the diluent 190 and the syrup or concentrate 194 are mixed and the mixture 198 of the diluent 190 and the syrup or concentrate 194 exits from the bottom of the spout 170, where the mixture has been agitated, whipped, foamed and/or frothed. The mixture 198 may continue to be mixed, agitated, whipped, foamed and/or frothed after exiting the spout 170 and while in a cup (not shown) that the mixture 198 has been poured into.

The cover 150 is coupled to the dispenser head 110 and covers at least portions of the necessary components and conduits (not shown) of the dispenser head 110. The cover 150 may enclose the top, sides, and portions of the front of the dispenser head 110, above the button 120. The button 120 remains exposed for user interface. The cover 150 includes a region 152 on the front of the cover 150 so that a label 154 is attached thereto for identifying the beverage, or mixture 198, that is to be dispensed through the spout 170. The cover 150 is a one-piece component according to some exemplary embodiments, but the cover 150 may be multi-components, such as the region 152 being a separate component, according to other exemplary embodiments.

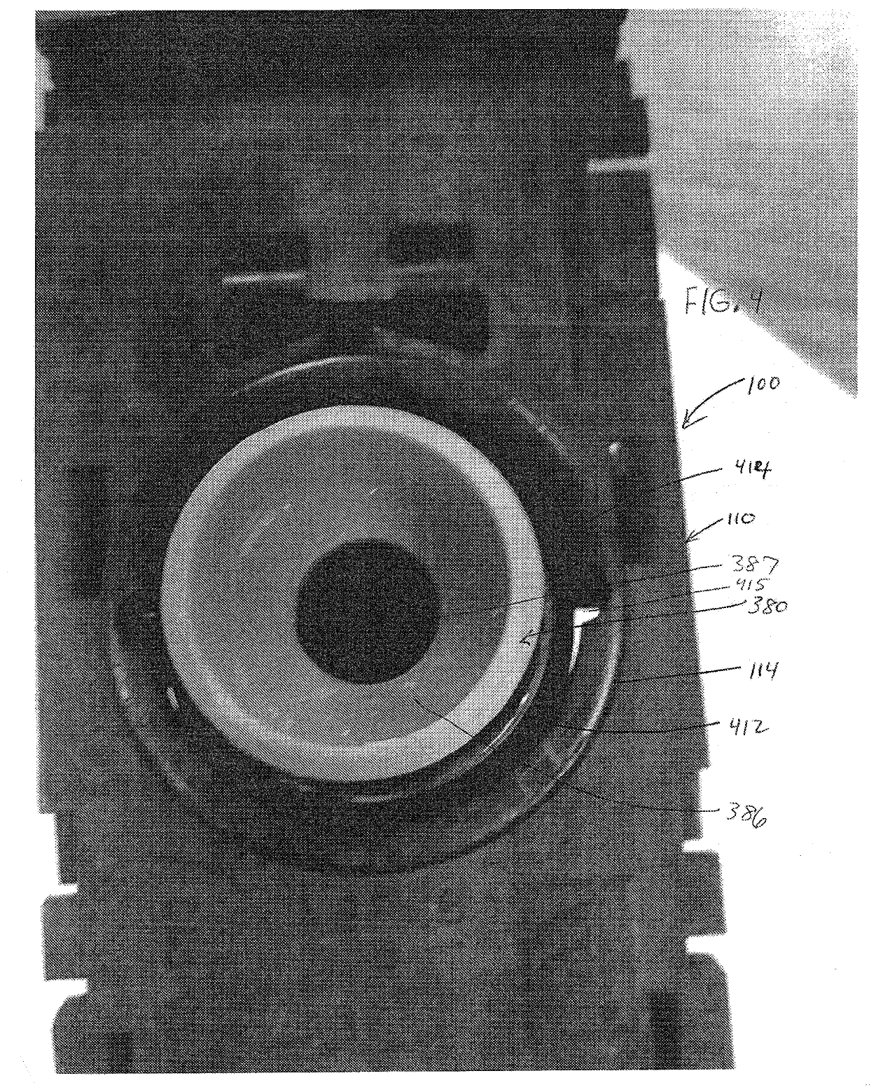

The spout 170 is typically fabricated using plastic or some other polymer, but the spout 170 may be fabricated using some other materials that is known to be used by people having ordinary skill in the art in accordance with other exemplary embodiments. The spout 170 is coupled to the bottom of the dispenser head 110 where a portion of the top of the spout 170 is inserted into the channel (not shown) of the dispenser head 110. The spout 170 includes a generally circular vertical wall 172 extending from the bottom of the dispenser head 110, when attached thereto, and a generally conical wall 174 extending away from the end of the generally circular vertical wall 172. In certain other exemplary embodiments, the spout 170 includes a second generally circular vertical wall (not shown) extending from the bottom of the conical wall 174 in a direction away from the vertical wall 172. Although an exemplary embodiment of the shape of the spout 170 has been described herein, other shapes may be used for the spout 170 in accordance with other exemplary embodiments pursuant to the knowledge of people having ordinary skill in the art and having the benefit of the present disclosure. A top portion of the generally circular vertical wall 172 is inserted into the channel (not shown) of the dispenser head 110 to facilitate the coupling of the spout 170 to the dispenser head 110. The spout 170 includes a diffuser 380 (FIG. 3) positioned within the spout 170, or at least partially within the spout 170, which is described in further detail below, for whipping, foaming and/or frothing of the diluent 190 with the syrup or concentrate 194 to form the mixture 196.

Although one exemplary embodiment of the post-mix beverage dispenser 100 is shown and described, any one or more of the dispenser head 110, the cover 150, and the spout 170 may be modified without departing from the scope and spirit of the exemplary embodiment.

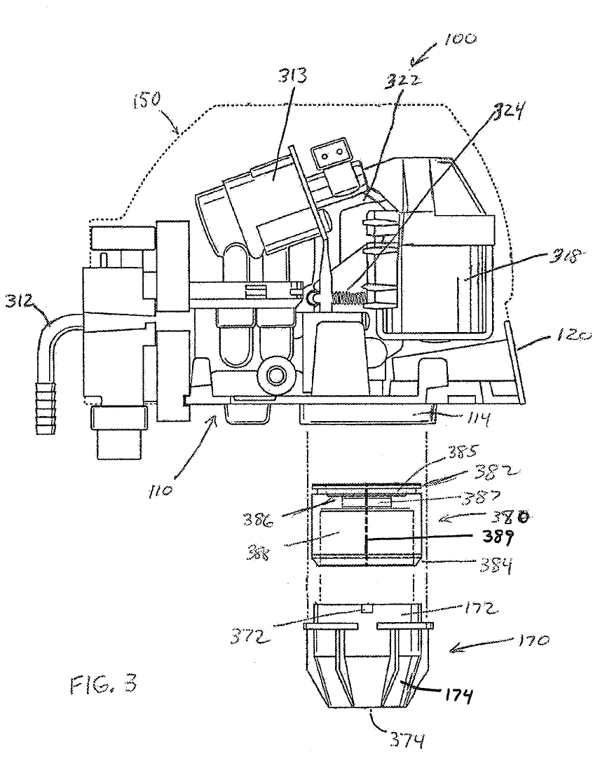

FIG. 2 shows a partially fragmented perspective view of a post-mix beverage dispenser 200 in accordance with another exemplary embodiment of the present invention. The components of the post-mix beverage dispenser 200 include a dispenser head 210, a cover 250, and a spout 170. The dispenser head 210 is similar to dispenser head 110 (FIG. 1), except that dispenser head 210 includes a push-lever 220 coupled to the dispenser head 210 and extending downwardly from the bottom of the dispenser head 210. The push-lever 220 is used for dispensing the diluent 190 and the syrup or concentrate 194 which forms the mixture 198, instead of the button 120 (FIG. 1) as part of the dispenser head 110 (FIG. 1). The cover 250 is similar to cover 150 (FIG. 1) except that cover 250 has been modified to fit over the dispenser head 210 since dispenser head 210 does not include the button 120 (FIG. 1). The spout 170 is coupled to the dispenser head 210 in a similar manner as the spout 170 is coupled to the dispenser head 110 (FIG. 1) and also includes the diffuser 380 (FIG. 3) disposed at least partially within the spout 170, which is described in further detail below, for whipping, foaming and/or frothing of the diluent 190 with the syrup or concentrate 194 to form the mixture 196 as it exits the spout 170.

Although another exemplary embodiment of the post-mix beverage dispenser 200 is shown and described, any one or more of the dispenser head 210, the cover 250, and the spout 170 may be modified without departing from the scope and spirit of the exemplary embodiment.

FIG. 3 shows a partially exploded side perspective view of the post-mix beverage dispenser 100 illustrating the diffuser 380 in accordance with an exemplary embodiment of the present invention. The post-mix beverage dispenser 100 includes the dispenser head 110, the cover 150, shown in phantom, the spout 170, and the diffuser 380. The dispenser head 110 includes inlet conduits 312, typically two but may be a different number of inlet conduits, in which one is connected to a fluid line (not shown) extending to a diluent source (not shown), typically water, while the other is connected to a second fluid line (not shown) extending to a source of a concentrate or a syrup (not shown). The dispenser head 110 also includes flow regulators 313, typically two—one for the diluent stream and one for the concentrate or syrup stream, that are used to adjust the amount of water and concentrate delivered through the diffuser 380 and the spout 170. The dispenser head 110 also includes the button or switch 120 that electrically activates a solenoid 318 which creates a magnetic field causing an arm 322 to move against the bias of a spring 324 and open valves to allow the diluent stream, or water stream, and concentrate steam or syrup stream to flow into a mixing chamber (not shown) located within the diffuser 380. The dispenser head 110 may include other conduits and chambers for electrical lines, concentrate and diluent passageways, motors as necessary, etc. These components are traditional and well-known in the art, and therefore are not described in detail herein. Dispenser head 110 having other configurations and componentry, such as dispenser head 210 (FIG. 2) or other types, may also be used in the present invention.

The diffuser 380 includes an upper end 382 and a lower end 384. The upper end 382 is inserted within the inner wall (not shown) of the dispenser head 110. According to some exemplary embodiments, the upper end 382 is friction fitted to the inner wall (not shown) of the dispenser head 110 or includes a device (not shown), such as an o-ring fabricated from rubber, that surrounds the upper end 382 and facilitates the friction fit with the inner wall (not shown). The lower end 384 is inwardly tapered according to some exemplary embodiment, but it may not be tapered in other embodiments. In the embodiments where the lower end 384 is inwardly tapered, the lower end 384 is shaped to fit within the interior of the spout's 170 conical wall 174. The diffuser 380 includes a primary mixing chamber 385 extending from the upper end 382 toward the lower end 384 but does not extend to the lower end 384. A base 386 is formed at the bottom of the primary mixing chamber 385 and extends radially and horizontally inward from an interior wall of the diffuser 380 toward a centerline 389 of the diffuser 380 but does not extend entirely to the centerline 389 of the diffuser 380. The base 386 is formed at a zero-degree incline according to some exemplary embodiments, but may be formed with an incline, such as with a downward slope extending from the interior wall of the diffuser 380 toward the centerline 389 of the diffuser 380. The base 386 also forms a secondary mixing chamber 388 extending from the bottom of the base 386 towards and through the lower end 384 of the diffuser 380. A diffuser channel 387 is formed within the diffuser 380 through the base 386 and extends along and around the centerline 389 of the diffuser 380, thereby fluidly connecting the primary mixing chamber 385 to the secondary mixing chamber 388. The diffuser channel 387 is circular in shape, but it may be a different geometric or non-geometric shape according to other exemplary embodiments. The diffuser channel 387 is smaller in diameter than both the primary mixing chamber 385 and the secondary mixing chamber 388. Additional details regarding the diffuser 380 will be shown and explained in further detail below.

The spout 170 includes one or more keys 372 formed and/or coupled to the upper outer perimeter of the vertical wall 172 of the spout 170. These keys 372 are inserted into the key slots 116 (FIG. 1) formed in the dispenser head's 110 outer wall 114, thereby causing the upper part of the vertical wall 172 to be inserted into the channel (not shown) formed between the dispenser head's 110 outer wall 114 and the inner wall (not shown). Once the spout's 170 keys 372 are inserted into the key slots 116 (FIG. 1), the spout 170 is then rotated in either a clockwise or counter-clockwise direction for coupling the spout 170 to the dispenser head 110. Once the spout 170 is coupled to the dispenser head 110, the diffuser 380 is positioned within a cavity (not shown) formed within the interior of the spout 170.

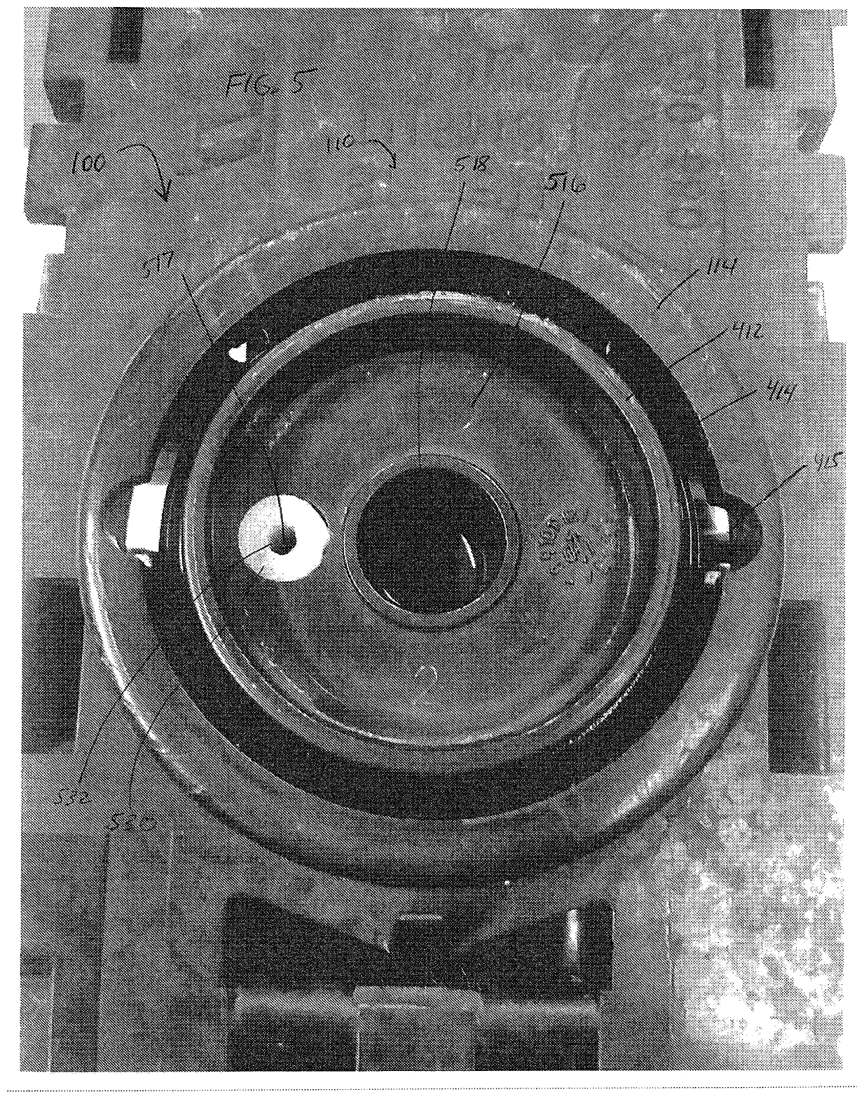

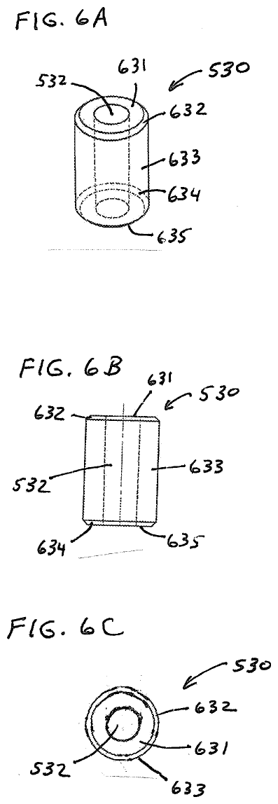

FIG. 4 shows a partial bottom view of the post-mix beverage dispenser 100 with the spout 170 (FIG. 3) removed in accordance with an exemplary embodiment of the present invention. FIG. 5 shows a partial bottom view of the post-mix beverage dispenser 100 with the spout 170 (FIG. 3) and the diffuser 380 (FIG. 4) removed in accordance with an exemplary embodiment of the present invention. Referring to FIGS. 4 and 5, the post-mix beverage dispenser 100 includes the outer wall 114 at a bottom end of the dispenser head 110 and the inner wall 412 formed concentrically within the outer wall 114. As mentioned before, the channel 414 is formed between the outer wall 114 and the inner wall 412. A dispensing base 516 is formed recessed within the inner wall 412, where the dispensing base 516 forms a diluent outlet port 517 and a concentrate or syrup outlet port 518. The diluent outlet port 517 is fluidly coupled to the diluent source (not shown) and is positioned along the outer portion of the dispensing base 516. A diluent nozzle 530 is inserted, typically by friction-fit, into the diluent outlet port 517 such that the bottom of the diluent nozzle 530 is substantially in the same plane as the dispensing base 516 and does not extend beyond the surface of the dispensing base 516 according to certain exemplary embodiments. The diluent nozzle 530 includes a diluent channel 532 extending therethrough that is smaller in diameter than the diluent outlet port 517, thereby providing for a higher velocity exit stream for the diluent 190 (FIG. 1). The concentrate or syrup outlet port 518 is fluidly coupled to the concentrate or syrup source (not shown) and is formed and positioned centrally through the dispensing base 516. The concentrate or syrup outlet port 518 is formed in a recessed manner to the surface of the dispensing base 516, but it may be formed such that the concentrate or syrup outlet port 518 is formed along the same plane as the surface of the dispensing base 516 in other exemplary embodiments.

A top end of the diffuser 380 is inserted into the area surrounded by the inner wall 412 and is substantially in contact with a portion of the dispensing base 516. The diffuser 380 is friction-fitted with the interior side of the inner wall 412, either itself or through an o-ring coupled around the diffuser 380. The diffuser's 380 base 386 is aligned over the dispensing base 516 when the diffuser 380 is coupled to the inner wall 412, such that the diluent 190 (FIG. 1) exiting the diffuser nozzle 530 makes high impact contact with the diffuser's 380 base 386 and allows the diluent 190 (FIG. 1) to scatter about and mix with the concentrate or syrup 194 (FIG. 1) that is exiting he concentrate or syrup outlet port 518. The diffuser channel 387 is aligned with the concentrate or syrup outlet port 518, such that the concentrate or syrup 194 (FIG. 1) exits the concentrate or syrup outlet port 518 and is directed towards the diffuser channel 387. Prior to entering the diffuser's 380 channel 387, the concentrate or syrup 194 (FIG. 1) is impacted with diluent 190 (FIG. 1) that is being scattered off of the diffuser's 380 base 386. The concentrate or syrup 194 (FIG. 1) and the diluent 190 (FIG. 1) commence mixing, agitating, whipping, and frothing with one another prior to entering the diffuser channel 387 and continue mixing, agitating, whipping, and frothing with one another as the mixture 198 (FIG. 1) proceeds through the diffuser channel 387, through the spout 170 (FIG. 3), and into the cup (not shown).

With reference now to FIGS. 3-5, the circumferential top edge of the spout 170 is configured to be coupled to the dispenser head 110 by inserting the top edge of the spout 170 into the channel 414 and aligning the one or more keys 372 of the spout 170 with the one or more key holes 415 formed along an inner portion of the outer wall 114. Once the keys 372 are inserted into the key holes 415, the spout 170 is coupled to the dispenser head 110 by a twist-turn frictional fit so that it is removably attached to the dispenser head 110 for cleaning purposes and the like. Once the spout 170 is inserted into the channel 414 and is turned about a quarter-turn, the spout 170 is locked in place. Typically, the spout 170 is defined by generally cylindrical upper portion, which tapers at a lower portion thereof to an outlet 374 through which the mixture 198 (FIG. 1), or beverage, is dispensed.

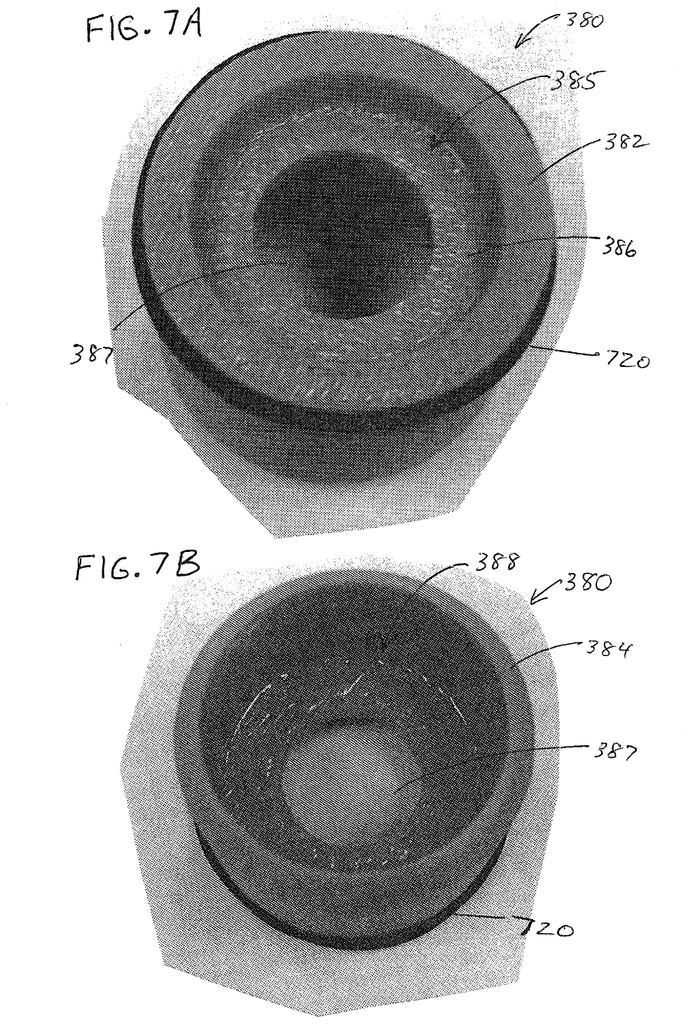

FIG. 6A shows a top perspective view of the diluent nozzle 530 in accordance with an exemplary embodiment of the present invention. FIG. 6B shows a top view of the diluent nozzle 530 in accordance with an exemplary embodiment of the present invention. FIG. 6C shows a side view of the diluent nozzle 530 in accordance with an exemplary embodiment of the present invention. Referring to FIGS. 6A, 6B, and 6C, the diluent nozzle 530 includes a top side 631, a side wall 633, and a bottom side 635. According to certain exemplary embodiments, the diluent nozzle 530 also includes a top transition 632, which extends from the outer edges of the top side 631 to the upper outer edges of the side wall 633, and a bottom transition 634, which extends from the outer edges of the bottom side 635 to the bottom outer edges of the side wall 633. The top transition 632 and the bottom transition 634 are oriented at an angle of forty-five degrees extending from the side wall 633 to the top side 631 and the bottom side 633, respectively; however, this angle may be different in other exemplary embodiments. However, in other exemplary embodiments, there may be only one or none of the top transition 632 and bottom transition 634, in which case the side wall 633 may extend to either or both the top side 631 and the bottom side 635. The diluent nozzle 530 is substantially cylindrically shaped according to some exemplary embodiments, but the shape may be any other geometric or non-geometric shape in other exemplary embodiments. Further, the diluent nozzle 530 defines the channel 532 that extends from the top side 631 to the bottom side 635, where such channel 532 allows the passage of diluent 190 (FIG. 1) to pass through. According to certain exemplary embodiments, the channel 532 is cylindrical in shape, however, in other exemplary embodiments, the channel 532 may be another geometric shape or non-geometric shape. Further, according to some exemplary embodiments, the channel 532 may have an opening that is smaller at the bottom side 635 than an opening at the top side 631. Although certain shapes and relative dimensions regarding the diluent nozzle 530 are shown and illustrated in FIGS. 6A, 6B, and 6C, the diluent nozzle 530 may be altered and may have differing dimensions and/or additional features without departing from the scope and spirit of the exemplary embodiment.

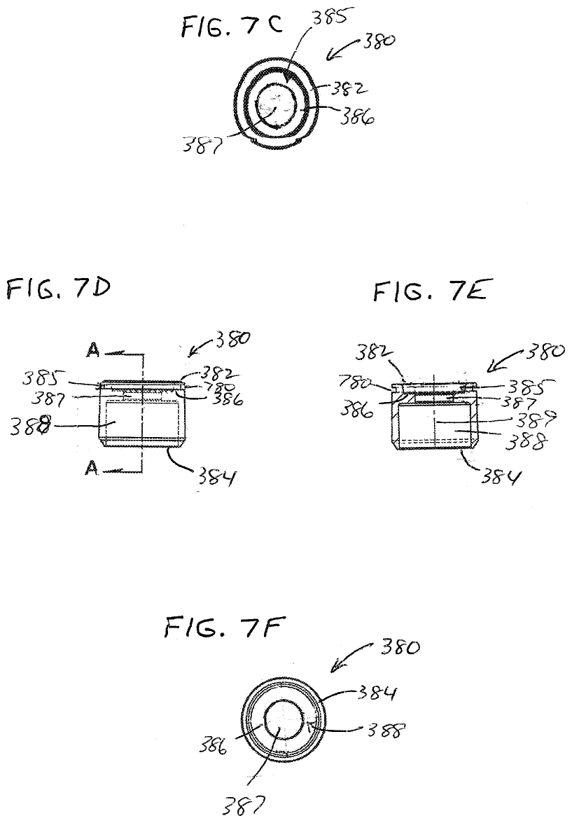

FIG. 7A shows a top perspective view of the diffuser 380 in accordance with an exemplary embodiment of the present invention. FIG. 7B shows a bottom perspective view of the diffuser 380 in accordance with an exemplary embodiment of the present invention. FIG. 7C shows a top view of the diffuser 380 in accordance with an exemplary embodiment of the present invention. FIG. 7D shows a side view of the diffuser 380 in accordance with an exemplary embodiment of the present invention. FIG. 7E shows a cross-sectional view of the diffuser 380 along A-A in FIG. 7D in accordance with an exemplary embodiment of the present invention. FIG. 7F shows a bottom view of the diffuser 380 in accordance with an exemplary embodiment of the present invention. Referring to FIGS. 7A-7F, the diffuser 380 includes an upper end 382 and a lower end 384. The upper end 382 is inserted within the inner wall (not shown) of the dispenser head 110. The lower end 384 is inwardly tapered according to some exemplary embodiment, but it may not be tapered in other embodiments. The diffuser 380 includes a primary mixing chamber 385 extending from the upper end 382 toward the lower end 384 but does not extend to the lower end 384. A base 386 is formed at the bottom of the primary mixing chamber 385 and extends radially and horizontally inward from an interior wall of the diffuser 380 toward a centerline 389 of the diffuser 380 but does not extend entirely to the centerline 389 of the diffuser 380. The base 386 is formed at a zero-degree incline according to some exemplary embodiments, but may be formed with an incline, such as with a downward slope extending from the interior wall of the diffuser 380 toward the centerline 389 of the diffuser 380. The base 386 also forms a secondary mixing chamber 388 extending from the bottom of the base 386 towards and through the lower end 384 of the diffuser 380. A diffuser channel 387 is formed within the diffuser 380 through the base 386 and extends along and around the centerline 389 of the diffuser 380, thereby fluidly connecting the primary mixing chamber 385 to the secondary mixing chamber 388. The diffuser channel 387 is circular in shape, but it may be a different geometric or non-geometric shape according to other exemplary embodiments. The diffuser channel 387 is smaller in diameter than both the primary mixing chamber 385 and the secondary mixing chamber 388. The diffuser 380 also includes a recess 780 formed around the outer wall of the diffuser 380 above the diffuser channel 387 and below the upper end 382. A device 720, such as an o-ring, is positioned about the top portion of the diffuser 380 within the recess 780 for providing a seal between the outer surface of the diffuser 380 and the inner surface of the dispenser head's 110 inner wall 412 (FIG. 4) when coupled thereto. Although certain shapes and relative dimensions regarding the diffuser 380 are shown and illustrated in FIGS. 7A-7E, the diffuser 380 may be altered and may have differing dimensions and/or additional features without departing from the scope and spirit of the exemplary embodiment.

According to certain exemplary embodiments of present invention, there is an elimination of bacterial collection due to surfaces adhesion from diluent. As the diluent is mixed, it does not pass over or through any restrictive surface area or orifices, i.e. the all surface area is accessible to cleaning and there are not restrictive or inaccessible surface areas that can accumulate bacterial growth.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims. It is therefore, contemplated that the claims will cover any such modifications or embodiments that fall within the scope of the invention.

What is claimed is:

1. A diffuser for use in a post-mix beverage dispenser, comprising:
a cylindrical wall having an inner surface and an outer surface; and
a diffuser base extending inwardly from the inner surface towards a centerline axis extending axially through the center of the cylindrical wall, wherein the diffuser base forms a channel within the middle of the diffuser base, the centerline axis extending axially through the center of the channel;
wherein the diffuser base is positioned near a top end of the cylindrical wall and away from the bottom end of the cylindrical wall.

2. The diffuser of claim 1, wherein the bottom end of the cylindrical wall comprises a tapered edge.

3. The diffuser of claim 2, wherein the tapered edge tapers inwardly.

4. The diffuser of claim 3, wherein the tapered edge tapers inwardly at a forty-five degrees angle.

5. The diffuser of claim 1, wherein the outer surface of the cylindrical wall forms a recess extending circumferentially about an upper portion of the cylindrical wall, the recess being located vertically above the diffuser base.

6. The diffuser of claim 5, further comprising an o-ring positioned within the recess, the o-ring extending outwardly away from the outer surface of the cylindrical wall when positioned within the recess.

7. The diffuser of claim 1, wherein the channel is circular.

8. A post-mix beverage dispenser, comprising:
a dispenser head comprising:
a generally cylindrical outer wall formed at the bottom of the dispenser head and extending outwardly therefrom;
a generally cylindrical inner wall formed interior of the outer wall and extending outwardly from the bottom of the dispenser head 110, thereby defining a channel between the outer wall and the inner wall; and
a dispensing base is formed recessed within the interior of the inner wall, wherein the dispensing base forms a diluent outlet port and a concentrate or syrup outlet port, wherein the concentrate or syrup outlet port is located centrally within the dispensing base and is fluidly coupled to a flow of a concentrate or syrup, wherein the diluent outlet port is located within the dispensing base and located along the outer portion of the dispensing base between the outer circumference of the concentrate or syrup outlet port and the inner wall and is fluidly coupled to a flow of a diluent,
a diffuser comprising:
a cylindrical wall having an inner surface and an outer surface; and
a diffuser base extending inwardly from the inner surface towards a centerline axis extending axially through the center of the cylindrical wall, wherein the diffuser base forms a channel within the middle of the diffuser base, the centerline axis extending axially through the center of the channel, wherein the diffuser base is positioned near a top end of the cylindrical wall and away from the bottom end of the cylindrical wall, wherein a top edge of the diffuser is coupled to the interior portion of the inner wall of the dispenser head, wherein the channel is aligned with the concentrate or syrup outlet port and a portion of the diffuser base is aligned with the diluent outlet port, and
a spout disposed over and around the diffuser once the diffuser is coupled to the dispenser head and coupled to the dispenser head when a top portion of the spout is inserted into the channel.

9. The post-mix beverage dispenser of claim 8, further comprising a diluent nozzle inserted into and coupled within the diluent outlet port, the diluent nozzle defining a diluent channel therein where the diluent channel has a smaller diameter that the diluent outlet port, and wherein the diluent channel is fluidly coupled to the flow of the diluent from the diluent outlet port.

10. The post-mix beverage dispenser of claim 8, wherein the outer surface of the cylindrical wall of the diffuser forms a recess extending circumferentially about an upper portion of the cylindrical wall, the recess being located vertically above the diffuser base.

11. The post-mix beverage dispenser of claim 10, further comprising an o-ring positioned within the recess, the o-ring extending outwardly away from the outer surface of the cylindrical wall when positioned within the recess, the o-ring providing a friction fit between the diffuser and the inner wall of the dispenser head.

12. The post-mix beverage dispenser of claim 8, wherein the bottom end of the cylindrical wall of the diffuser comprises a tapered edge.

13. The post-mix beverage dispenser of claim 12, wherein the tapered edge tapers inwardly.

14. The post-mix beverage dispenser of claim 13, wherein the tapered edge tapers inwardly at a forty-five degrees angle.

15. The post-mix beverage dispenser of claim 8, wherein the cylindrical outer wall formed at the bottom of the dispenser head defines at least one key slot therein, wherein the outer surface of a top edge of the spout defines a key extending outwardly therefrom, and wherein the key is inserted into the key slot when coupling the spout to the dispenser head and the spout is rotated thereafter to lock the spout with the dispenser head.
